(19) United States
(12) Patent Application Publication
(10) Pub. No.: US 2002/0197362 A1
(43) Pub. Date: Dec. 26, 2002

(54) Method for bottling sake and bottled sake

(76) Inventor: Shigehiro Kondo, Osaka-fu (JP)

Correspondence Address: SQUIRE, SANDERS & DEMPSEY L.L.P, 600 HANSEN WAY, PALO ALTO, CA, 94304-1043, US

(21) Appl. No.: 09/887,916

(22) Filed: Jun. 21, 2001

(51) Int. Cl. A23B 4/00

(52) U.S. Cl. 426/131

(57) ABSTRACT

A method of bottling SAKE and the resulting bottled SAKE are disclosed. The bottling method includes placing SAKE and an ear of rice, preferably of the same variety from which the SAKE was brewed, inside a translucent bottle. The bottling method may further include separate pasteurization of the SAKE and ear of rice to eliminate bacteria, yeast, and other organisms associated with the ear of rice without impacting the SAKE quality. Seeing the variety of rice may permit the customers to recognize high quality rice as opposed to inexpensive varieties that yield undesirable SAKE.

### CROSS-REFERENCE TO PRIORITY APPLICATIONS

This application claims priority to Japanese patent application serial number #2001-38108, by inventor Mr. Shigehiro Kondo, entitled “The Method of SAKE Bottling and Bottled Sake,” filed on Feb. 15, 2001, by Applicant CHOYA UMESHU CO., LTD.

### BACKGROUND OF THE INVENTION

1. Field of the Invention

This patent relates to methods of bottling SAKE and to bottled SAKE.

2. Description of the Related Art

Although SAKE is brewed using rice as the base material SAKE rice is distinguishable from table rice. Knowing what kind of rice has been used in brewing the SAKE is one method of checking its quality. However, because it is rare for ordinary customers to find out the variety of rice used for making the SAKE, it is difficult for customers to judge the quality of SAKE. As a result, many customers purchase highly priced SAKE that unbeknownst to them is low in quality because it is made from low quality rice.

The variety of rice generally used as table rice is called HANMAI and is very different from SAKAMAI which is the variety of rice used to brew SAKE. Varieties of rice used for brewing SAKE include YAMADA-NISHIKI, GOHYAKUMANGOKU, OMACHI, and HATTAN-NISHIKI that contain less fat and protein than table rice varieties. These rice varieties have more white center white part, and are collectively called SHUZOUKOUTEKIMAI

Nowadays, less of the aforementioned SHUZOUKOUTEKIMAI is used to make SAKE. Rather, HANMAI, the inexpensive variety, and imported rice varieties that are much less suitable for making SAKE are often used. It is very rare for consumers to see SAKE from SHUZOUKOUTEKIMAI. Therefore, a system and method for enabling customers to recognize the quality of the SAKE and instilling customer confidence is necessary.

### SUMMARY

To solve the abovementioned problems, this disclosure presents bottled SAKE and a method for inserting a plant, such as an ear of rice, into a transparent SAKE bottle for distinguishing the SAKE based on the variety of rice used to make the SAKE and for instilling customer confidence, without compromising the quality of the SAKE. The structure of the disclosed bottled SAKE causes the pasteurized ear of rice to be fully soaked in pasteurized SAKE and sealed in the bottle.

Inserting an ear of rice, from which the drink is brewed, into the SAKE bottle to distinguish it from inexpensive SAKE may instill customer confidence and show the customers that the SAKE is made from real SHUZOUKOUTEKIMAI.

Although liqueurs containing fruit or plant such as UMESHU (Japanese UME-plum Liqueur) exist, alcoholic beverages other than sweet liqueurs do not come in bottles containing fruits or plants. In the case of SAKE, SAKE with gold flakes in the bottle exists, but other products with something in the bottle do not.

A problem arising from inserting an ear of rice into the SAKE bottle is that the organisms attached to the ear of rice will damage the quality of SAKE. Generally, SAKE is bottled and pasteurized at 65 degrees Celsius; however, if an un-pasteurized ear of rice is inserted into the bottle, the associated bacteria, mold, and yeast will not be eliminated at this temperature.

The resulting SAKE does not suffer from potential infections associated with insertion of the ear of rice in the bottle that cannot be alleviated by pasteurization of the SAKE at 65 degrees Celsius because the ear of rice is pre-pasteurized before being inserted in the SAKE bottle.

### BRIEF DESCRIPTION OF THE SERVERAL VIEWS OF THE DRAWINGS

The accompanying drawing, that is incorporated in and constitutes a part of this specification, illustrates an embodiment of the invention and together with the description serves to explain the principles of the invention.

FIG. 1 is a diagram of a SAKE bottle with a pasteurized ear of rice inserted therein.

### DETAILED DESCRIPTION OF THE INVENTION

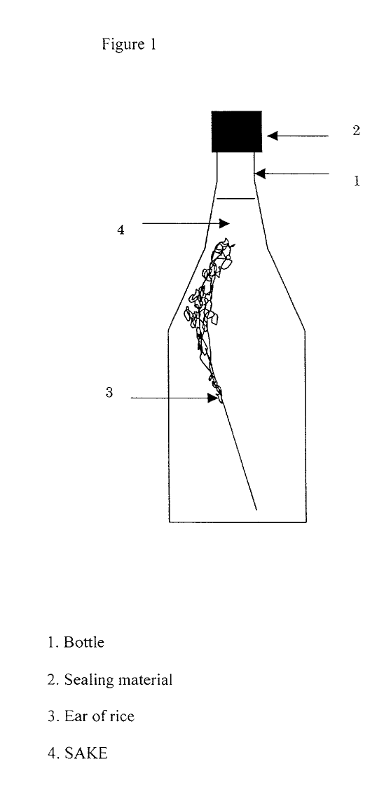

FIG. 1 is a diagram of a bottle 1 that is made of transparent or translucent material and has a desired size and shape. The top of the bottle 1 is sealed with a sealer 2, such as a stopper or a cap. An ear of rice 3 and SAKE 4, which are pasteurized before sealing, are bottled and sealed inside. For convenience, the term “translucent” shall include “transparent.”

The bottle 1 may be made of translucent glass or translucent synthetic material that is not offensive to the taste of SAKE.

The ear of rice 3 is preferably of the same rice variety used to brew the SAKE 4, is inserted in the bottle 1 to fully soak in SAKE 4, and can be observed through the bottle 1 due to the clarity of bottle 1 and of the SAKE 4 liquid.

SAKE 4 is preferably pasteurized at 65 Celsius before being bottled. The rice ear 3 is also preferably pre-pasteurized because it is impossible to eliminate the bacteria, mold, and yeast that may exist on the ear of rice 3 at the pasteurizing temperature of SAKE. The rice ear 3 may be prepasteurized using some other method that will not diminish the SAKE quality. For example, the pasteurization process may use Alcohol, Hydrogen Peroxide (H₂O₂), Hypochlorous Acid (HClO), Sorbic Acid (CH₃CH═CHCH═CHCOOH), surfactants, boiled water, or a combination of these substances and techniques.

Seeing the ear of rice 3 and knowing that the SAKE 4 is made from the variety of rice showing through the bottle instills confidence in the customer. The ear of rice 3 will distinguish this SAKE from other inexpensive SAKE. Pre-pasteurizing the ear of rice 3 will help maintain the quality of SAKE.

The foregoing description of the preferred embodiments of the present invention is by way of example only, and other variations and modifications of the above-described embodiments and methods are possible in light of the foregoing teaching. The embodiments described herein are not intended to be exhaustive or limiting. The present invention is limited only by the following claims.

What is claimed is:

1. A method comprising:
disposing SAKE in a translucent bottle;
disposing an ear of rice in the translucent bottle; and
sealing the translucent bottle.

2. The method of claim 1, wherein the SAKE is brewed from rice of the same variety as that of the ear of rice.

3. The method of claim 1, further comprising:
pasteurizing the SAKE.

4. The method of claim 1, further comprising:
pasteurizing the ear or rice.

5. The method of claim 1, further comprising:
pasteurizing the SAKE; and
pasteurizing the ear of rice separately from the pasteurization of SAKE.

6. The method of claim 5, wherein the method of pasteurizing the ear of rice includes using at least one of: Alcohol, Hydrogen Peroxide (H₂O₂), Hypochlorous Acid (HClO), Sorbic Acid (CH₃CH═CHCH═CHCOOH), surfactants, or boiled water.

7. An article comprising:
a translucent container;
an alcoholic beverage product brewed from rice and disposed in the translucent container; and
an ear of rice disposed in the translucent container.

8. The article of claim 7, wherein the ear of rice is of the same variety of rice from which the alcoholic beverage was brewed.

9. The article of claim 7, wherein:
the SAKE is pasteurized; and
the ear of rice is pasteurized separately from the pasteurization of the SAKE.
